(19) United States
(12) Patent Application Publication
(10) Pub. No.: US 2024/0406770 A1
(43) Pub. Date: Dec. 5, 2024

(54) METHOD AND APPARATUS FOR REMOTE DEVICE STATUS MONITORING IN MISSION-CRITICAL COMMUNICATIONS (MCC)

(71) Applicant: Samsung Electronics Co., Ltd., Suwon-si (KR)

(72) Inventors: Kiran GAJULA, Bangalore (IN); Siva GUNDUR, Bangalore (IN)

(21) Appl. No.: 18/635,897

(22) Filed: Apr. 15, 2024

Related U.S. Application Data
(63) Continuation of application No. PCT/KR24/04078, filed on Mar. 29, 2024.

(30) Foreign Application Priority Data
Jun. 2, 2023 (IN) 202341038070
Dec. 19, 2023 (IN) 202341038070

(51) Int. Cl. H04W 24/08; H04L 65/1045; H04W 4/14; H04W 4/90

(52) U.S. Cl. CPC H04W 24/08; H04L 65/1045; H04W 4/14; H04W 4/90

(57) ABSTRACT

Disclosed is a method for monitoring, by a server, remote device status in mission-critical communications. The method comprise receiving, from a dispatcher device among a plurality of remote devices, a first monitoring request for monitoring a status of at least one responder device among the plurality of remote devices; transmitting, to the at least one responder device, a second monitoring request based on one or more policies corresponding to the received first monitoring request; receiving, from the at least one responder device, a message including information which is associated with device status collected by the at least one responder device; and transmitting, to the dispatcher device, the received message.

### CROSS-REFERENCE TO RELATED APPLICATIONS

This application is a continuation of International Application No. PCT/KR2024/004078 designating the United States, filed on Mar. 29, 2024, in the Korean Intellectual Property Receiving Office and claiming priority to Indian Provisional Patent Application No. 202341038070, filed on Jun. 2, 2023, in the Indian Patent Office, and to Indian Complete patent Application No. 202341038070, filed on Dec. 19, 2023, in the Indian Patent Office, the disclosures of each of which are incorporated by reference herein in their entireties.

### BACKGROUND

### Field

The disclosure relates to the field of wireless communication systems. For example, the present disclosure relates to a method and an apparatus for remote device status monitoring in mission-critical communications (MCC).

### Description of Related Art

During a time of crisis or an emergency, reliable public safety communications may be preferred to safeguard the lives of the people. Further, the reliable communications improve response time and inter-agency coordination. The reliable public safety communications are carried out by MCC which may be preferred by public safety teams in order to carry out their missions to save people during the time of the crisis or emergency.

The MCC plays a vital role in providing essential mission-critical services such as mission-critical push-to-talk (MCPTT) services, mission-critical (MC) video services, MCData services, and other similar services. These mission-critical services enable a User Equipment (UE) to initiate communication with one or more users/UEs, where the UE along with the one or more other UEs may form one or more groups. The MCC enables offline communication between the one or more UEs. The MCC provides all levels of emergency response, coordinates response activities, and connects groups, thus providing seamless connectivity in critical situations.

The MCC offers a set of services/features to provide efficient, fast, secure communication among the one or more UEs. Some of the features include, but are not limited to, group communication, private communication, emergency calls, imminent peril calls, ambient call, first to answer calls, voice and video communication, location sharing, a short message service, a file distribution, a private call back request, a floor control, a transmission control, remotely initiated calls, broadcast calls, emergency alerts, enhanced status, etc.

The development and widespread adoption of the mission-critical services standard by the 3rd generation partnership project (3GPP) are highly driven by customers themselves including public safety operators, multiple countries, etc. Furthermore, multiple network operators have also shown significant interest in MCData services like short data service (SDS) and file distribution (FD).

Despite significant advancements in the MCC, there remain various limitations and challenges with conventional methods for effectively monitoring remote devices in mission-critical communications. Remote device monitoring, for example, monitoring of the one or more UEs plays an important role in reliability and performance of the mission-critical services. However, existing monitoring methods and systems often fall short of addressing specific requirements and complexities associated with MCC deployments for the remote device monitoring. For example, the conventional and existing monitoring methods fail to adequately address particular demands of MCData services, hindering the seamless integration and optimal performance of such systems and methods within mission-critical communication networks. Additionally, in some scenarios, the one or more UEs may not always be in communication with each other due to a bad network/discharge state of the battery, unavailability due to another operation, etc., which cannot be communicated to the public safety teams due to lack of communication between them. This may create a possibility that the public safety team may not be able to get the required information from the one or more UEs of the critical situation. Hence, there is a possibility of disconnection of services (rescue services) carried out by the public safety team in case of the critical situation. This may also increase safety risk for the user trapped in the critical situation.

Therefore, there lies a need for an improved monitoring system and method that can address the above-mentioned issues and the limitations of the existing systems and methods.

### SUMMARY

Embodiments of the disclosure may provide a method and a system for remote device status monitoring in mission-critical communications (MCC).

In an embodiment, a method for monitoring, by a server, remote device status in mission-critical communications is disclosed. The method may comprise receiving, from a dispatcher device among a plurality of remote devices, a first monitoring request for monitoring a status of at least one responder device among the plurality of remote devices. The method may comprise transmitting, to the at least one responder device, a second monitoring request based on one or more policies corresponding to the received first monitoring request. The method may comprise receiving, from the at least one responder device, a message including information about device status related to the at least one responder device. The method may comprise transmitting, to the dispatcher device, the received message.

In an embodiment, a method for monitoring, by a responder device among a plurality of client devices, remote device status in mission-critical communications is disclosed. The method may comprise receiving, from a server, a second monitoring request for monitoring a status of the responder device among the plurality of remote devices, wherein the second monitoring request is based on one or more policies corresponding to a first monitoring request received by the server from a dispatcher device. The method may comprise identifying device status related to the responder device based on the received second monitoring request. The method may comprise transmitting, to the server, a message including information about the device status related to the responder device.

In an embodiment, a server for monitoring remote device status in mission-critical communications is disclosed. The server may comprise a memory storing instructions and at least one processor configured to, when executes the instructions, cause the server to perform operations. The operations may comprise receiving, from a dispatcher device among a plurality of remote devices, a first monitoring request for monitoring a status of at least one responder device among the plurality of remote devices. The operations may comprise transmitting, to the at least one responder device, the second monitoring request based on one or more policies corresponding to the received first monitoring request. The operations may comprise receiving, from the at least one responder device, a message including information about device status related to the at least one responder device. The operations may comprise transmitting, to the dispatcher device, the received message.

To further clarify the advantages and features of the present disclosure, a more particular description of the disclosure will be provided with reference to various example embodiments thereof, which are illustrated in the appended drawings. It is appreciated that these drawings depict only example embodiments and are therefore not to be considered limiting of the scope of the disclosure.

### BRIEF DESCRIPTION OF THE DRAWINGS

These and other features, aspects, and advantages of certain embodiments of the present disclosure will be more apparent from the following detailed description, taken in conjunction with the accompanying drawings in which like characters represent like parts throughout the drawings, and in which:

FIG. 1 is a diagram illustrating an example environment of a system having a plurality of remote devices and a server, according to various embodiments;

FIG. 2 is a block diagram illustrating an example configuration of a server, according to various embodiments;

FIG. 3 is a block diagram illustrating an example configuration of a system, according to various embodiments;

FIG. 4 is a flowchart illustrating an example method for remote device status monitoring in mission-critical communications, according to various embodiments;

FIG. 5 is a signal flow diagram illustrating an example method for the remote device status monitoring in the mission-critical communications, according to various embodiments; and

FIGS. 6A, 6B and 6C are diagrams illustrating an example scenario for the remote device status monitoring in the mission-critical communications, according to various embodiments.

Further, skilled artisans will appreciate that elements in the drawings are illustrated for simplicity and may not have necessarily been drawn to scale. For example, the flowcharts illustrate the method in terms of various steps involved to help to improve understanding of aspects of the present disclosure. Furthermore, in terms of the construction of the device, one or more components of the device may have been represented in the drawings by conventional symbols, and the drawings may show only those specific details that are pertinent to understanding various embodiments of the present disclosure so as not to obscure the drawings with details that will be readily apparent to those of ordinary skill in the art having the benefit of the description herein.

### DETAILED DESCRIPTION

Reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory and are not intended to be restrictive thereof.

Reference throughout this disclosure to “an aspect”, “another aspect” or similar language may refer, for example, to a particular feature, structure, or characteristic described in connection with an embodiment being included in at least one embodiment of the present disclosure. Thus, appearances of the phrase “in an embodiment”, “in another embodiment”, and similar language throughout this disclosure may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Various example embodiments of the present disclosure will be described below in greater detail with reference to the accompanying drawings.

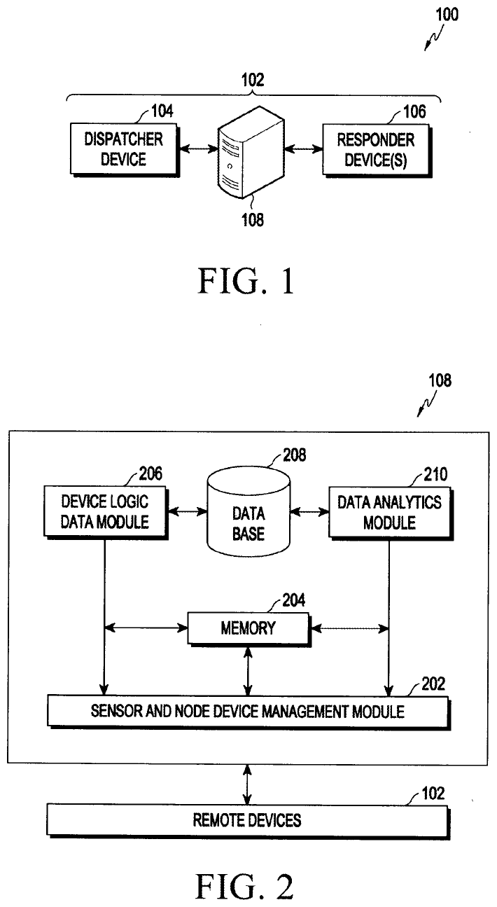

FIG. 1 is a diagram illustrating an example environment of a system 100 having a plurality of remote devices 102 and a server 108, according to various embodiments. FIG. 2 is a block diagram illustrating an example configuration of the server 108, according to various embodiments. In various embodiments, the system 100 may be configured to monitor a remote device status in mission-critical communications (MCC), without departing from the scope of the present disclosure.

In an embodiment, the system 100 includes, but is not limited to, the server 108, and the plurality of remote devices 102 among other examples, which is explained in greater detail below.

In an embodiment, the plurality of remote devices 102 may include a dispatcher device (e.g., including various communication circuitry) 104 and at least one responder device (e.g., including various communication circuitry) 106.

In an embodiment, the dispatcher device 104 may be interchangeably referred to as an MCX dispatcher and a first MCData client, without departing from the scope of the present disclosure. In an embodiment, the dispatcher device 104 may include various circuitry and be an authorized user/MCx client which assists in resolving emergency situations by establishing communication with the at least one responder device 106 based on the availability of different information. The dispatcher device 104 may be a part of all kinds of communications among the at least one responder device 106.

In an embodiment, the at least one responder device 106 may include various circuitry and be referred to as a second MCData Client, MCData client devices, or a client device, without departing from the scope of the present disclosure.

Each of the dispatcher device 104 and the at least one responder device 106 are configured to communicate with each other via the server 108. The server 108 may include a sensor and node device management module (e.g., including various processing circuitry and/or executable program instructions) 202, a memory 204, a device logic data module (e.g., including various processing circuitry and/or executable program instructions) 206, a database 208, and a data analytics module (e.g., including various processing circuitry and/or executable program instructions) 210. The node device management module 202, the device logic data module 206, and the data analytics module 210 may be integrally referred as at least one processor.

The sensor and node device management module 202 may be configured to collect data/a monitoring request from the plurality of remote devices 102 (for example, the dispatcher device 104) and send the received data/the monitoring request to the device logic data module 206. Further, the device logic data module 206 may be configured to process the monitoring request by validating the monitoring request.

Once the monitoring request is validated, the validated monitoring request is forwarded to the data analytics module 210 for further processing. The data analytics module 210 may be configured to analyze the validated monitoring request and assign one or more policies to the validated monitoring request received from the device logic data module 206. In an embodiment, after assignment of the one or more policies to the monitoring request, the data analytics module 210 may be configured to transmit the monitoring request to the plurality of remote devices 102 (for example, the at least one responder device 106) via the sensor and node device management 202.

In an embodiment, the one or more policies corresponding to the validated monitoring request may be stored in the memory 204. Further, the memory 204 stores the operational command (e.g. instructions) corresponding to the sensor and node device management 202, the data analytics module 210, and device logic data module 206. When the at least one processor executes the instructions, the at least one processor may cause the server 108 to perform operations of the server 108 described herein.

In an embodiment, the database 208 may be configured to store the validated monitoring request from the device logic data module 206, the monitoring request having the assigned one or more policies from the data analytics module 210, etc. In an embodiment, the database 208 may include, but is not limited to, a time-series database, a relational database, n-memory database etc., without departing from the scope of the present disclosure.

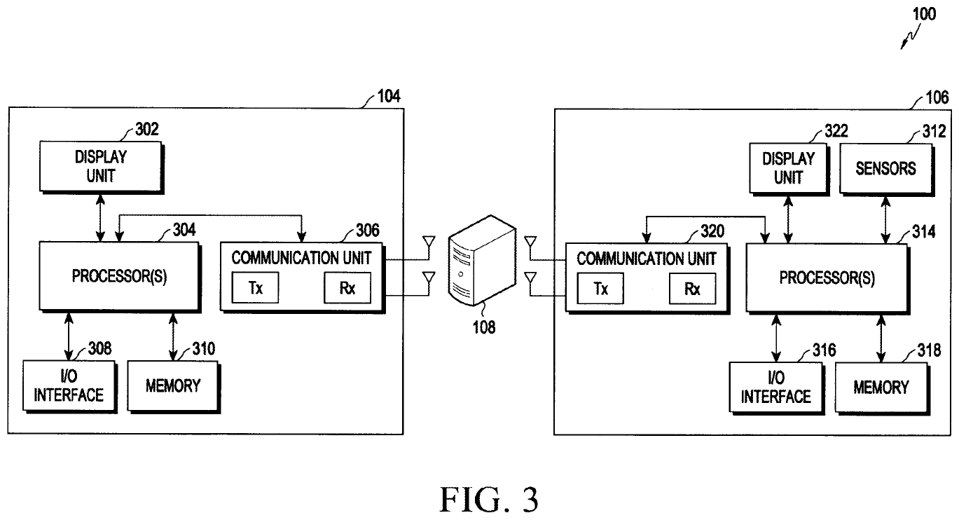

FIG. 3 is a block diagram illustrating an example configuration of the system 100, according to various embodiments.

In an embodiment, the dispatcher device 104 may include a display unit (e.g., including a display) 302, a processor (e.g., including processing circuitry and may also be referred to as at least one processor, one or more processors) 304, a communication unit (e.g., including communication circuitry) 306, an input/output (I/O) interface (e.g., including input/output circuitry) 308, and a memory 310.

In an embodiment, the at least one responder device 106 may include sensors (also be referred to as a plurality of sensors, one or more sensors, at least one sensor) 312, a processor (e.g., including processing circuitry and may also be referred to as at least one processor, one or more processors) 314, an input/output (I/O) interface (e.g., including input/output circuitry) 316, a memory 318, a communication unit (e.g., including communication circuitry) 320, and a display unit (e.g., including a display) 322. Each of the communication unit 306 and the communication unit 320 may include a transmitter (Tx) and a receiver (Rx). Therefore, at times, the dispatcher device 104 can also act as a receiver and the at least one responder device 106 can also act as a transmitter, without departing from the scope of the present disclosure.

In an embodiment, the processor 304 may be operatively coupled to the communication unit 306, the memory 310, the display device 302, and the I/O interface 308. The processor 304 may be configured for processing, executing, or performing a plurality of operations disclosed throughout the disclosure. According to an embodiment, the processor 304 may correspond to at least one data processor for executing processes in the dispatcher device 104. The processor 304 may correspond to a specialized processing unit such as integrated system (bus) controllers, memory management control units, floating point units, graphics processing units, digital signal processing units, etc. In an embodiment, the processor 304 may correspond to a central processing unit (CPU), a graphics processing unit (GPU), or both. Further, the processor 304 may be one or more general processors, digital signal processors, application-specific integrated circuits, field-programmable gate arrays, servers, networks, digital circuits, analog circuits, combinations thereof, or other now known or later developed devices for analyzing and processing data. The processor 304 may execute a software program, such as code generated manually (e.g., programmed) to perform the desired operation. In an embodiment, the processor 314 of the at least one responder device 106 may be operatively coupled to the communication unit 320, the memory 318, the display device 322, the sensors 312, and the I/O interface 308. Further, the processor 314 may have the same configuration as that of the processor 304 and accordingly, a detailed description of the same may be omitted herein for the sake of brevity of the present disclosure. For example, the processor 304 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment, the memory 310 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 310 is communicatively coupled with the processor 304 to store bit streams or processing instructions for completing the process. Further, the memory 310 may include an operating system for performing one or more tasks of the system 100. The memory 310 may also store data blocks generated by the dispatcher device 104 or the at least one responder device 106 for future processing. Further, the memory 318 of the at least one responder device 106 has the same configuration as that of the memory 310 and accordingly, a detailed description of the same is omitted herein for the sake of brevity of the present disclosure.

In an embodiment, the I/O interface 308 may refer, for example, to hardware and/or software components that enable data communication in the dispatcher device 104, other devices, or systems. The I/O interface 308 may serve as a communication medium for exchanging information, commands, or data with other devices or systems. The I/O interface 308 may be a part of the processor 304 or maybe a separate component. The I/O interface 308 may be created in software or maybe a physical connection in hardware. The I/O interface 308 may be configured to connect with an external network, external media, the display, or any other components, or combinations thereof. The external network may be a physical connection, such as a wired Ethernet connection, or may be established wirelessly. Further, the I/O interface 316 of the at least one responder device 106 has the same configuration as that of the I/O interface 308, and accordingly, a detailed description of the same is omitted herein for the sake of brevity of the present disclosure.

In an embodiment, each of the dispatcher device 104 and the at least responder device 106 may be configured to execute a remote device status monitoring in a mission-critical communication (MCC) which is explained in subsequent paragraphs.

The processor 304, through the communication unit 306, of the dispatcher unit 104, may be configured to transmit the monitoring request to the server 108 for monitoring a status of the at least one responder device 106. In an embodiment, the processor 304 through the communication unit 306 may initiate a request to the at least one responder device 106 for fetching the remote device status. The request may be initiated using a new request type, e.g., remote-monitoring-request. In a non-limiting example, a format of initiating the remote-monitoring-request is illustrated below in Table 1:

```
TABLE 1
MESSAGE sip:opf_psi@ptt.mnc031.mcc450.3gppnetwork.org SIP/2.0
To:<sip:opf_psi@ptt.mnc031.mcc450.3gppnetwork.org>;Board=pre_3;Story=sds.group.
001
Via: SIP/2.0/UDP
[2001:db8:a01:2128:172:21:28:164]:19665;branch=z9hG4bK249;psimsessid=9
CSeq: 1 MESSAGE
From: <sip:999101110000@samsung.com>;tag=BT_TAG_25;psimsessid=9 Call-ID:
pre_3_sds.group.001_1645151548_9
Contact: <sip:[2001:db8:a01:2128:172:21:28:164]:19665>
Content-Type: multipart/mixed;boundary=mcptt2
Max-Forwards: 70
Content-Length: 733
P-Access-Network-Info: 3GPP-E-UTRAN-FDD;utran-cell-id-
3gpp=31041001234567890
User-Agent: FirstNet-Device
--mcptt2
Content-Type: application/vnd.3gpp.mcdata-info+xml
<?xml version=”1.0” encoding=”UTF-8”?>
<mcdatainfo xmlns=”urn:3gpp:ns:mcdataInfo:1.0”
xmlns:xs=”http://www.w3.org/2001/XMLSchema”>
<mcdata-Params>
  <request-type>remote-monitoring-request</request-type>
</mcdata-Params>
</mcdatainfo>
--mcptt2
Content-Type: application/resource-lists+xml;charset=utf-8
Content-Disposition: recipient-list
<?xml version=”1.0” encoding=”UTF-8”?>
<resource-lists xmlns=”urn:ietf:params:xml:ns:resource-lists”
xmlns:xsi=”http://www.w3.org/2001/XMLSchema-instance” x
mlns:cc=”urn:ietf:params:xml:ns:copyControl”>
<list>
<entry uri=”sip:999101160000@samsung.com”/>
  </list>
</resource-lists>
```

Further, in an embodiment, the server 108 may be configured to assign the one or more policies corresponding to the monitoring request transmitted by the dispatcher device 104. In an embodiment, the assignment may be done based on a validation of the monitoring request. Once the one or more policies are assigned, the server 108 may be configured to transmit the monitoring request to the at least one responder device 106 based on the one or more policies corresponding to the monitoring request. The monitoring request may be received by the server 108 from the dispatcher device 104.

In an embodiment, the at least one responder device 106 may be configured to notify a response message to the dispatcher device 104, where the response message indicates a reception of the monitoring request. Further, the at least one responder device 106 may be configured to collect information regarding device status, which is associated with the at least one responder device 106. In an embodiment, the device status may include, for example, and without limitation, at least one of a location, vital signs, a roaming, an accelerometer, a connection type, a network signal strength, status of a battery charge of the at least one responder device 106, an emergency alert status condition, a presence status, various sensor data, an active call status, and a profile status. Further, the at least one responder device 106 may transmit the collected information in a message including a payload content type to the dispatcher device 104 via the server 108.

In an embodiment, the at least one responder device 106 may be configured to monitor the status, detected by the plurality of sensor 312, associated with the at least one responder device 106. In an embodiment, the processor 314 of the at least one responder device 106 may be configured to receive the monitoring request, through the communication unit 320, for monitoring a status of the at least one responder device 106. The processor 314 may be configured to notify the response message indicating the reception of the monitoring request to the dispatcher device 104 via the server 108 and the communication unit 320. Further, the processor 314 may be configured to collect information regarding the device status, operational values, and user status associated with the at least one responder device 106. In an embodiment, the information regarding the device status, the operational values, and the user status associated with the at least one responder device 106 is collected by the plurality of sensors 312, without departing from the scope of the present disclosure. Further, the processor 314 may be configured to transmit the collected information in the message including the payload content type to the dispatcher device 104 via the server 108 and the communication unit 320, without departing from the scope of the present disclosure.

For example, the at least one responder device 106 may respond with device status data as requested by the dispatcher device 104, in response to the initiated request by the dispatcher device 104. The dispatcher device 104 may further use the device status to make better decisions. Further, the payload content type may be new payload types (the device status and the user status) which may be defined with different types of payload content formats such as JSON, XML, or TLV format. The user status may be a part of the device status as well. Further, the dispatcher device 104 may be configured to display the requested/collected information (the device status) from the at least one responder device 106 on the display unit 302. Based on the available information, the dispatcher device 104 may make effective decisions, that is, public safety agent heads can make better decisions in emergency/crisis situations to guide/aid the at least one responder device 106. In an embodiment, the dispatcher device 104 may receive the device status periodically from the at least one responder device 106, without departing from the scope of the present disclosure.

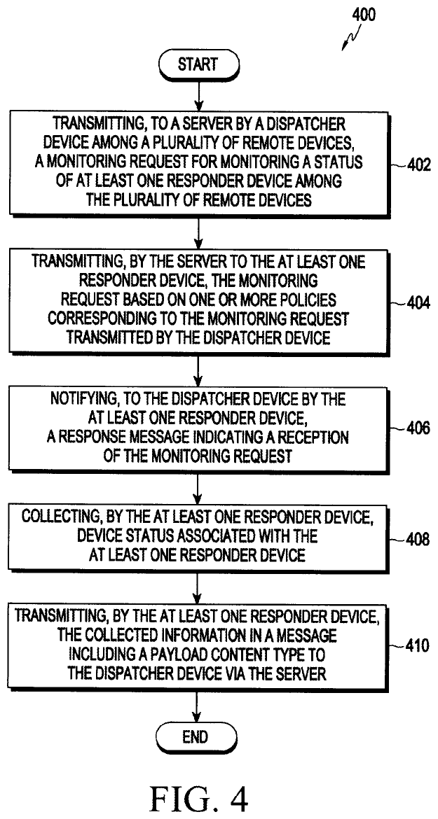

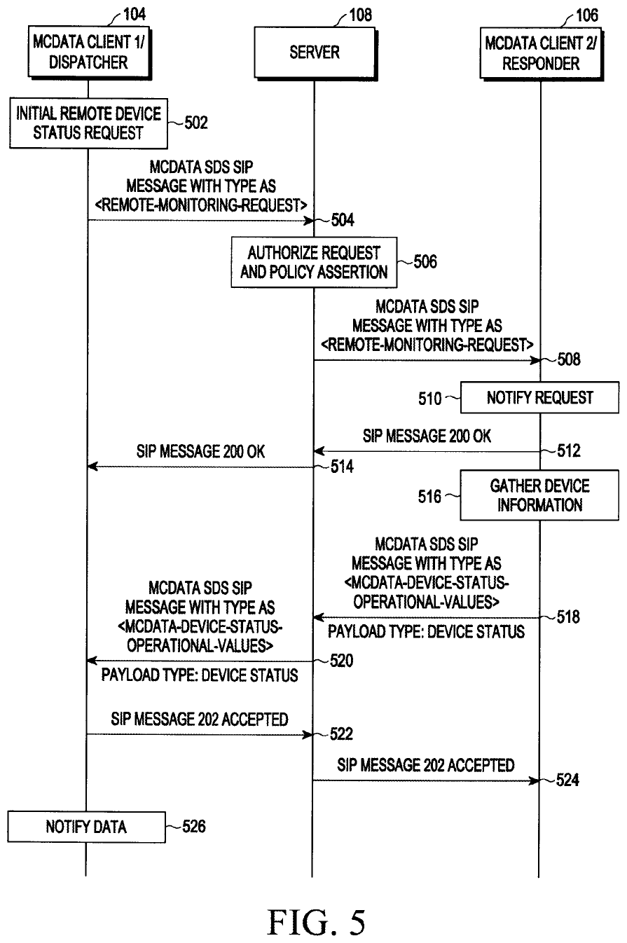

Further, an example method for the remote device status monitoring in the MCC is explained in in greater detail below with reference to FIGS. 4 and 5.

FIG. 4 is a flowchart illustrating an example method 400 for the remote device status monitoring in mission-critical communications (MCC), according to various embodiments. FIG. 5 is a signal flow diagram 500 illustrating an example method for remote device status monitoring in mission-critical communications, according to various embodiments.

The method 400 can be performed by programming, for example, based on instructions retrieved from non-transitory computer readable media. The computer readable media can include machine-executable or computer-executable instructions to perform all or portions of the described method. The computer readable media may be, for example, digital memories, magnetic storage media, such as magnetic disks and magnetic tapes, hard drives, or optically readable data storage media. The method 400 is performed by the system 100 as explained in conjunction with FIGS. 1, 2 and 3, without departing from the scope of the present disclosure.

In an embodiment, the system 100 after performing the method 400 fetches emergency state and location of the at least one responder device 106 along with many other device statuses and/or status of the at least one responder device 106. The method 400 performed by the system 100 further includes a procedure for fetching signal strength along with many other device statuses and/or statuses of the at least one responder device 106.

The method 400 may include a series of operations illustrated at step 402 through step 408 of FIG. 4 and block 502 to block 526 of FIG. 5. The method 400 begins at step 402.

At step 402, the method includes transmitting, to the server 108 by the dispatcher device 104 among the plurality of remote devices 102, the monitoring request for monitoring the status of the at least one responder device 106 among the plurality of remote devices 102. Further, for transmitting the monitoring request for monitoring the status of the at least one responder device 106, the method includes generating a request message including the new request type corresponding to the monitoring request for monitoring the status of the at least one responder device 106. The method includes transmitting by the dispatcher device 104, to the server 108, the request message including the new request type after applying an encryption protocol to the generated message.

In an embodiment, the monitoring request in the request message may correspond, for example, to a request for monitoring a plurality of status parameters associated with the plurality of remote devices 102. In an embodiment, the request message is a Session Initiation Protocol (SIP) message indicating the monitoring request. Further, the plurality of status parameters may include, for example, the active call status, the presence status, the emergency alert status condition, the status of the charge of the battery, a cell coverage, a signal strength, a current connection status, a current location, a roaming status, a profile status, a status of one or more sensors associated with the plurality of remote devices 102, and a user health status indicated by sensor data corresponding to the plurality of remote devices 102. Further, the sensor data corresponds to data collected by user wearable devices among the plurality of remote devices 102.

For example, at block 502, the first MCData client device/the dispatcher device 104 initiates a request for the remote device status, e.g., the remote monitoring request. The request may be initiated in the form of a MCData SDS SIP MESSAGE with request type as a <remote-monitoring request> to the second MCData client device/the at least one responder device 106. In an embodiment, the message may be a mission-critical short data service message (MCData SDS SIP MESSAGE), without departing from the scope of the present disclosure. Further, the MCData SDS SIP Message may also be able to provide file distribution, IP streaming etc. Further, the request may be sent as part of all MCData requests from the MCData User to the server 108 and vice-versa. Further, the request (MCData-info) may have information like request-type, MCData-request-uri, MCData-calling-user-id, MCData-called-party-id, etc. The request-type in the MCData-info may describe the type of the request, for example, one-to-one-sds, group-sds, one-to-one-fd, group-fd etc. Based on the request type, requests may be parsed and handled.

The request is to be honored based on the status of the second MCData client device/the at least one responder device 106 as requested by the first MCData client device/the dispatcher device 104. Further, the request may be included in the MCData SDS SIP MESSAGE as <request-type> remote-monitoring-request </request-type> and transmitted to the second MCData client device/the at least one responder device 106 via the MCData server/server 108.

Further, prior to the transmission of the monitoring request, the method includes assigning, by the server 108, the one or more policies corresponding to the monitoring request transmitted by the dispatcher device 104, based on the validation of the monitoring request.

At step 404, the method includes transmitting, by the server 108 to the at least one responder device 106, the monitoring request based on the one or more policies corresponding to the monitoring request transmitted by the dispatcher device 104. For example, at block 504, the MCData server/server 108 receives the request in the form of MCData SDS SIP MESSAGE with type as a <remote-monitoring request>, from the first MCData client device/the dispatcher device 104. Further, at block 506, the MCData server/server 108 authorizes the request received from the first MCData client device/the dispatcher device 104 for the remote device status and may also assert the one or more policies associated with the transfer of the request to the second MCData client device/the at least one responder device 106. Further, at block 508, the second MCData client device/the at least one responder device 106 receives the MCData SDS MESSAGE with the type as the <remote-monitoring-request>, from the MCData server/server 108.

At step 406, the method includes notifying, to the dispatcher device 104 by the at least one responder device 106, a response message indicating the reception of the monitoring request. The at least one responder device 106 may be configured to decrypt the received request message related to the monitoring request. In an embodiment, the response message is a SIP acknowledgment message that indicates a successful delivery of the SIP message. For example, at block 510, the second MCData client device 106 sends a notification message to notify the first MCData client device/the dispatcher device 104 regarding the acknowledgment of the reception of the request for the remote device status. The notification message may be sent to the first MCData client device/the dispatcher device 104 via the MCData server/server 108 in the form of SIP MESSAGE 200OK as shown at block 512 and block 514.

At step 408, the method includes collecting (or identifying), by the at least one responder device 106, the device status associated with the at least one responder device 106. In an embodiment, the device status includes at least one of the locations, vital signs, the roaming, the accelerometer, the connection type, the network signal strength, the status of the battery charge of the at least one responder device 106, the emergency alert status, the presence status, various sensor data, the active call status, and the profile status.

At step 410, the method includes transmitting, by the at least one responder device 106, the collected information in the message including the payload content type to the dispatcher device 104 via the server 108.

For example, at block 516, the second MCData client device/the at least one responder device 106 gathers information about the remote device status and further transmits the gathered information in the MCData SDS SIP MESSAGE with type as <remote-monitoring response>, e.g., MCData SDS SIP MESSAGE with type as <mcdata-device-status-operational-values> to the MCData server/server 108 (at block 518). The MCData SDS SIP MESSAGE including the gathered information is further transmitted to the first MCData client device/the dispatcher device 104 by the MCData server/server 108 (at block 520). The MCData SDS SIP MESSAGE may be transmitted with new payload types that may be defined with different types of payload content formats such as JSON, XML, or TLV format (as shown) where the payload type is the remote device status. Further, the new payload types may be identified by capturing network packets using Wireshark, without departing from the scope of the present disclosure. Further, the TLV format is an encoding scheme and includes a plurality of Information Elements (IE) indicating the plurality of status parameters associated with the plurality of remote devices and a type and reference corresponding to each of the plurality of status parameters. An example representation of the TLV format for sending the remote device status in MCData Short Data Service (SDS) payload is illustrated in Table 2:

TABLE 2

| | Information | | | | Length |
|---|---|---|---|---|---|
| IEI | Element | Type/Reference | Presence | Format | (Bytes) |
| 81 | Roaming | Roaming Type | O | TV | 1 |
| | | [0—Home n/w, | | | |
| | | 1—Roaming] | | | |
| 82 | Accelerometer | Acceleration | O | TV | 4 |
| | (in motion feet | Speed in feet/sec | | | |
| | per second) | | | | |
| 83 | Location | Location Info | O | TV | 16 |
| | (x, y, z axis) | | | | |
| 84 | Connection | Connectivity Type | O | TV | 1 |
| | Type (Wi-Fi | [0—WiFi, | | | |
| | or LTE) | 1—LTE] | | | |
| 85 | In Coverage, | Signal Strength in | O | TV | 1 |
| | signal strength | dBm | | | |
| 86 | Battery | Battery life & | O | TLV-E | 4-x |
| | (Charge %, | Charging Info | | | |
| | Charging and | | | | |
| | expected | | | | |
| | Battery life) | | | | |
| 87 | Emergency | Emergency Alert | C | TV | 1 |
| | Alert Status | Type (both | | | |
| | Condition | monitored & | | | |
| | | designated groups | | | |
| | | status required, | | | |
| | | strings will be | | | |
| | | required) | | | |
| 88 | Presence | Presence Status | O | TV | 1 |
| | Status | Type | | | |
| | | [0—UnAvailable, | | | |
| | | 1—Available, | | | |
| | | 2—DND] | | | |
| 89 | Active Call | Active Call Status | O | TV | 1 |
| | Status (LTE | Type | | | |
| | Phone Call or | [0—No Call, 1— | | | |
| | PTT call) | PTT call, 2—LTE | | | |
| | | Phone call] | | | |
| 8A | Profile status | Profile used by the | O | TV | 1 |
| | | User | | | |
| | | [0—Default | | | |
| | | (UnAuthenticated), | | | |
| | | 1—Normal] | | | |

From Table 2: TV stands for Time and value, where the TV has a fixed value, for example, 1byte. Further, TLV stands for Type, Length, and Value, where the TLV has a variable value. The TLV-encoded data stream contains code related to the type, the length's value, and the value. The TLV format is defined for sending the device status in the MCData SDS payload data, where the user status may also be part of the TLV format.

Further, another example representation of the TLV format for sending the remote user status in the MCData Short Data Service (SDS) payload is illustrated in Table 3:

TABLE 3

| | Information | | | | Length |
|---|---|---|---|---|---|
| IEI | Element | Type/Reference | Presence | Format | (Bytes) |
| 91 | Spo2 | Body Oxygen | O | TV | 1 |
| | | Level | | | |
| 92 | Heart-rate | Heart rate | O | TV | 1 |

The TLV format is defined for sending the device status in the MCData SDS payload data, where the user status may also be part of the TLV format. The TLV format has various advantages, some of which are explained below:
Sequences of the TLV format are easily searched using generalized parsing functions;
New message elements which are received at an older node can be safely skipped and the rest of the message can be parsed. This is similar to the way that unknown XML tags can be safely skipped;
Elements in the TLV format can be placed in any order inside the message body.
Elements in the TLV format are typically used in a binary format and binary protocols which makes parsing faster and the data smaller than in comparable text based protocols.

Further, the new payload content may also be defined to distinguish the remote device status and the user status from the existing payload content while transmitting the gathered information in the MCData SDS message. In an embodiment, the payload content type may be added to the MCData SDS message in accordance with 3GPP specification 24.282 (refer Table 4 for reference). This enables the sending of the device status based on the dynamic information related to the remote device monitoring requiring a new payload type with a new TLV format. Further, the new payload type is the device status and the user status. For sharing the remote device status/the user status, the TLV format has to be defined with new information elements, and further, the format for each information element is defined. Further, based on the payload content type, the payload is formed in the dispatcher device 104 (sender side) and parsed on the at least one responder device 106 (receiver side). Further, in a non-limiting example, a representation of each of the JSON format payload content and the XML format payload content for sending the remote device status in the MCData Short Data Service (SDS) payload is shown below in accordance with an embodiment:

JSON format payload content (Device Status)

```
“device status”: {
    “roaming”: “false”,
    “location”: {
  “x” : “2323244.232”,
  “y” : “10865783.32”
  “z” : “2323.12”
  }
    “connection-type” : “lte”,
    “signal-strength” : “−45db”,
    “battery” : “78%”,
    “emergency-status” : “false”,
....
.....
....
}
```

XML format payload content (Device Status)

```
<device status>
  <roaming>false</roaming>
  <location>
      <x>2323244.232</x>
      <y>10865783.32</y>
      <z>2323.12</z>
    </location>
  <connection-type>lte</connection-type>
  <signal-strength>−45db</signal-strength>
  <battery>78%</battery>
  <emergency-status>false</emergency-
status>
....
.....
}
```

JSON format payload content (User Status)

```
“user status”: {
  “spo2”: “98”,
  “heart-rate”: “104”
.....
....
}
```

XML format payload content (User Status)

```
<user status>
  <spo2>98</spo2>
  < heart-rate >104</ heart-rate >
</user status>
```

TABLE 4
Payload content type

| Bits | | | | | | | | |
|---|---|---|---|---|---|---|---|---|
| 8 | 7 | 6 | 5 | 4 | 3 | 2 | 1 | |
| 0 | 0 | 0 | 0 | 0 | 0 | 0 | 1 | TEXT |
| 0 | 0 | 0 | 0 | 0 | 0 | 1 | 0 | BINARY |
| 0 | 0 | 0 | 0 | 0 | 0 | 1 | 1 | HYPERLINKS |
| 0 | 0 | 0 | 0 | 0 | 1 | 0 | 0 | FILEURL |
| 0 | 0 | 0 | 0 | 0 | 1 | 0 | 1 | LOCATION |
| 0 | 0 | 0 | 0 | 0 | 1 | 1 | 0 | ENHANCED STATUS |
| 0 | 0 | 0 | 0 | 0 | 1 | 1 | 1 | Vlue allocated for use in |
| | | | | | | | | interworking (NOTE) |
| 0 | 0 | 0 | 0 | 1 | 0 | 0 | 0 | LOCATION ALTITUDE |
| 0 | 0 | 0 | 0 | 1 | 0 | 0 | 1 | LOCATION TIMESTAMP |
| 0 | 0 | 1 | 0 | 0 | 0 | 0 | 0 | DEVICE STATUS |
| 0 | 0 | 1 | 0 | 0 | 0 | 0 | 1 | USER STATUS |

All other values are reserved.
(NOTE):
Usage of this value is described in 3GPP TS 29.582

Further, at block 522 and block 524, the first MCData client device/the dispatcher device 104 sends an acknowledge message to the second MCData client device/the at least one responder device 106 via the MCData server/server 108 in the form of SIP MESSAGE 202, indicating an acceptance of the MCData SDS SIP MESSAGE with type as <remote-monitoring response>.

At block 526, the first MCData client device/the dispatcher device 104 notifies the received data indicating the requested remote device status.

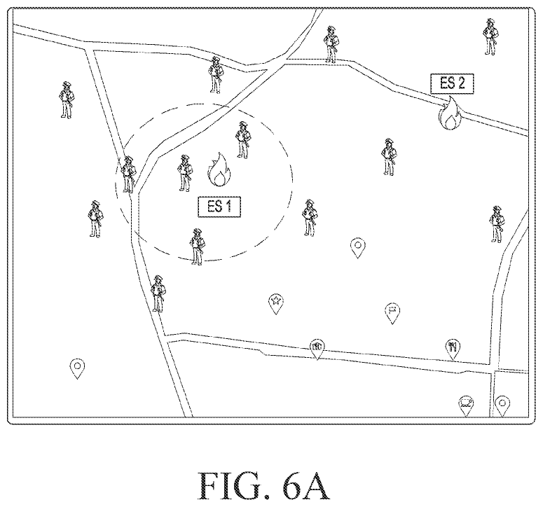

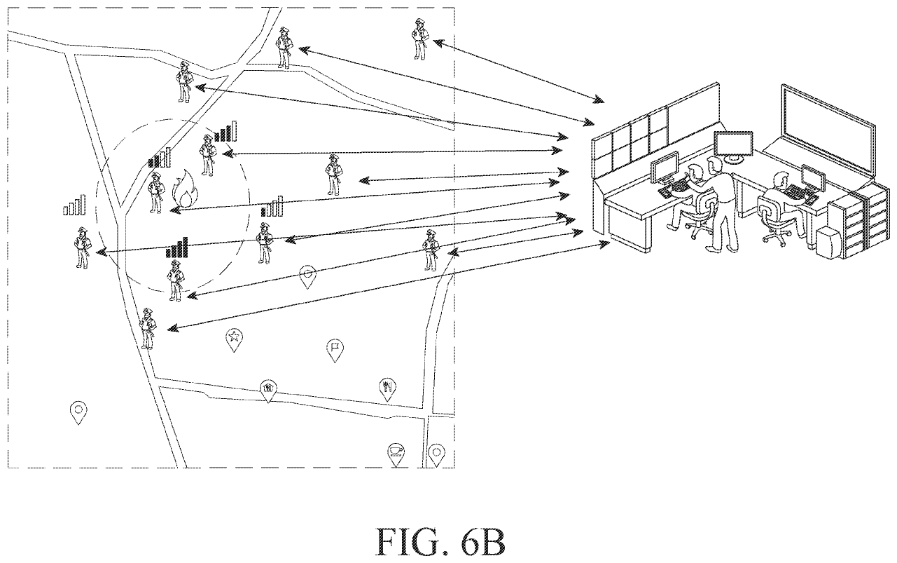

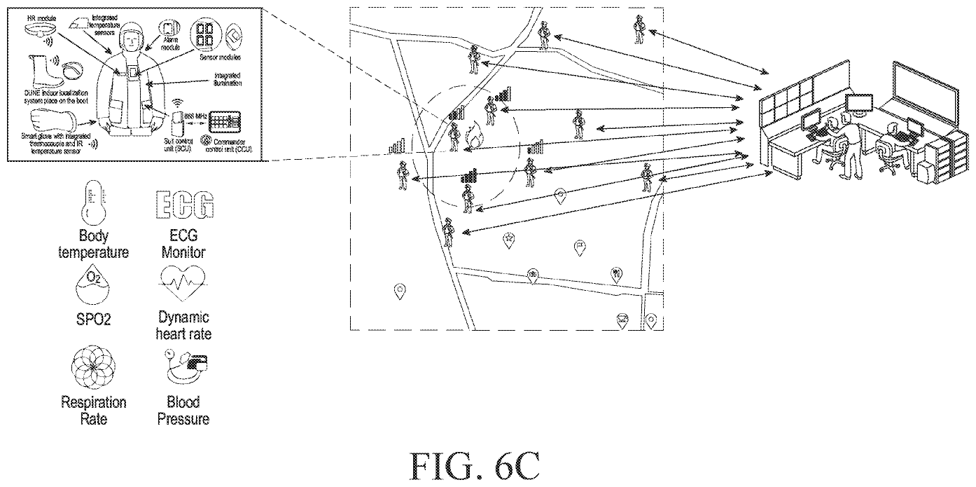

FIGS. 6A, 6B and 6C are diagrams illustrating an example scenario for the remote device status monitoring in the mission-critical communications, according to various embodiments.

In accordance with an example use case of an embodiment disclosed herein, the dispatcher device 104, in case of emergency situations (ES1), may fetch the emergency state of the at least one responder device 106 and may assign the available first responder device from the at least one responder device 106 to handle an upcoming crisis. Also, some of the responder devices may be already assigned in the case of a first emergency situation. When another emergency situation e.g., a second emergency situation (ES2) arises, the dispatcher device 104 may fetch the emergency state and location information of the at least one responder device 106 and may assign an available first responder device. This provides fetching of the emergency state, and location of the at least one responder device 106 along with many other device status/status of the at least one responder device 106.

Further, in accordance with another example use case of an embodiment disclosed herein, it is essential for the dispatcher device 104 to get full information, clear images, high resolution video calls, etc. of the crisis situation and with continuous communication to assist and/or handle the situation better. Whenever the signal strength of the at least one responder device 106 goes low, then there might be a possibility that the call may be dropped when the call is the high-resolution video call. However, the call may be downgraded from the high-resolution video call to a normal voice call to keep the call continued rather than performing no communication. The dispatcher device 104 may also fetch the signal strength of the at least one responder device 106 and may downgrade or upgrade the call based on a current signal strength. If the current signal strength goes to no service, then the dispatcher device 104 may assign a new first responder device.

In accordance with yet another example use case of the one or more embodiments disclosed herein, the dispatcher device 104 or an MC control center may request information such as at least one of the location, vital signs, the roaming, the accelerometer, the connection type, the network signal strength, status of the battery charge of the at least one responder device 106, the emergency alert status, the presence status, various sensor data, the active call status, and the profile status. etc., from the at least one responder device 106. Based on the available information the dispatcher device 104 may make effective decisions. In particular, the above disclosed method describes the procedure to remotely fetch the device status and health status of the at least one responder device 106 from the plurality of sensors 312 installed in the at least one responder device 106.

In accordance with yet another example use case of the one or more embodiments disclosed herein, the dispatcher device 104 or an MC control center may request information about the vital signs, for example, heart rate, oxygen level (spo2), body temperature, blood pressure, respiration rate., from the at least one responder device 106. Based on the available information, the dispatcher device 104 may make effective decisions and alert the at least one responder device 106 about his/her health condition so that the at least one responder device 106 may be able to take care of themselves. In one example, the dispatcher device 104 may make better decisions in emergency and/or crisis situations to guide and/or aid the at least one responder device 106 in many ways as described herein as a plurality of non-limiting examples given below:
by alerting when the oxygen level of the at least one responder device 106 goes to a dangerous level as he may not be in a position to realize it.
By sending a rescue team to the location of the at least one responder device 106 when his pulse goes below the normal level (for example, when he fainted due to various reasons),
sending assistance to the personnel who are having bad conditions doing their rescue operations & might not be in a position to realize their condition but reflected through Heart Rate, SPO2 levels to Dispatcher, etc.

The present disclosure may provide that, the dispatcher device 104 may select the best responder from the at least one responder device 106 depending on location, availability etc., and also anticipate disconnection with the at least one responder device 106 depending on the device status of the at least one responder device 106 and the user status. Further, the dispatcher device 104 may send necessary instructions to the best responder and also provide assistance to the at least one responder device 106 having a bad condition during the emergency situation. In one example, public safety agency heads may make better decisions in emergency and/or crisis situations to guide and/or aid the at least one responder device 106 in many ways as described herein as a plurality of non-limiting examples below:
By providing an alert to recharge the battery before going on a rescue operation;
By involving the right personnel who are near a disaster location based on the personnel's location information and who are not already occupied based on a currently active call status/emergency status;
By sending assistance to the person who is having bad condition while carrying out rescue operations and may not be in a position to realize his condition but may be reflected through heart rate, SPO2 levels to the dispatcher device 104, etc.; or
By directing the in-coverage the at least one responder device 106 to act as a UE-to-network relay for other out-of-coverage users in the vicinity of the in-coverage the at least one responder device 106. Thus, the coverage may be extended and may help in arranging more rescue teams for carrying out the rescue operation.

As would be apparent to a person in the art, various working modifications may be made to the method in order to implement various aspects of the disclosure as taught herein.

The drawings and the forgoing description give examples of various embodiments. Those skilled in the art will appreciate that one or more of the described elements may well be combined into a single functional element. Further, certain elements may be split into multiple functional elements. Elements from one embodiment may be added to another embodiment. For example, orders of processes described herein may be changed and are not necessarily limited to the manner described herein. It will also be understood that any of the embodiment(s) described herein may be used in conjunction with any other embodiment(s) described herein.

Moreover, the actions of any flow/line diagram need not be implemented in the order shown; nor do all of the acts necessarily need to be performed. Also, those acts that are not dependent on other acts may be performed in parallel with the other acts.

What is claimed is:

1. A method for monitoring, by a server, remote device status in mission-critical communications, the method comprising:
receiving, from a dispatcher device among a plurality of remote devices, a first monitoring request for monitoring a status of at least one responder device among the plurality of remote devices;
transmitting, to the at least one responder device, a second monitoring request based on one or more policies corresponding to the received first monitoring request;
receiving, from the at least one responder device, a message including information about device status related to the at least one responder device; and
transmitting, to the dispatcher device, the received message.

2. The method of claim 1, further comprising:
assigning, based on a validation of the received first monitoring request, the one or more policies corresponding to the received first monitoring request.

3. The method of claim 1, wherein the device status comprises at least one of a location, vital signs, a roaming, an accelerometer, a connection type, a network signal strength, status of a battery charge of the at least one responder device, an emergency alert status, a presence status, various sensor data, an active call status, and a profile status.

4. The method of claim 1, wherein receiving the first monitoring request comprises receiving a request message including a payload content type corresponding to the first monitoring request, and
an encryption protocol is applied to the request message.

5. The method of claim 4, wherein:
the first monitoring request in the request message corresponds to a request for monitoring a plurality of status parameters associated with the plurality of remote devices, and
the plurality of status parameters includes one or more of an active call status, a presence status, an emergency alert status condition, status of a charge of a battery, a cell coverage, a signal strength, a current connection status, a current location, a roaming status, a profile status, a status of one or more sensors associated with the plurality of remote devices, and a health status indicated by sensor data corresponding to the plurality of remote devices, and
wherein the sensor data corresponds to data collected by wearable devices among the plurality of remote devices.

6. The method of claim 4, wherein:
the request message comprises a Session Initiation Protocol (SIP) message indicating the monitoring request.

7. The method of claim 5, wherein:
the payload content type includes one of a TLV format, a JSON format, or an XML format, and
the TLV format includes a plurality of Information Elements (IE) indicating the plurality of status parameters associated with the plurality of remote devices and a type and reference corresponding to each of the plurality of status parameters.

8. The method of claim 1, wherein the message comprises a mission-critical short data service message.

9. A method for monitoring, by a responder device among a plurality of client devices, remote device status in mission-critical communications, the method comprising:
receiving, from a server, a second monitoring request for monitoring a status of the responder device among the plurality of remote devices, wherein the second monitoring request is based on one or more policies corresponding to a first monitoring request received by the server from a dispatcher device;
identifying device status related to the responder device based on the received second monitoring request; and
transmitting, to the server, a message including information about the device status related to the responder device.

10. The method of claim 9, further comprising:
transmitting, to the dispatcher device, a response message indicating a reception of the second monitoring request.

11. The method of claim 9, wherein the one or more policies corresponding to the first monitoring request is assigned based on the validation of the first monitoring request.

12. The method of claim 9, wherein the device status comprises at least one of a location, vital signs, a roaming, an accelerometer, a connection type, a network signal strength, status of a battery charge of the responder device, an emergency alert status, a presence status, various sensor data, an active call status, and a profile status.

13. The method of claim 9, wherein the message comprises a mission-critical short data service message.

14. A server for monitoring remote device status in mission-critical communications, the server comprising:
a memory storing instructions; and
at least one processor configured to, when executes the instructions, cause the server to perform operations comprising:
receiving, from a dispatcher device among a plurality of remote devices, a first monitoring request for monitoring a status of at least one responder device among the plurality of remote devices,
transmitting, to the at least one responder device, a second monitoring request based on one or more policies corresponding to the received first monitoring request,
receiving, from the at least one responder device, a message including information about device status related to the at least one responder device, and
transmitting, to the dispatcher device, the received message.

15. The server of claim 14, wherein the operations further comprises:
assigning, based on a validation of the received first monitoring request, the one or more policies corresponding to the received first monitoring request.

16. The server of claim 14, wherein the device status comprises at least one of a location, vital signs, a roaming, an accelerometer, a connection type, a network signal strength, status of a battery charge of the at least one responder device, an emergency alert status, a presence status, various sensor data, an active call status, and a profile status.

17. The server of claim 14, wherein receiving the first monitoring request comprise receiving a request message including a payload content type corresponding to the first monitoring request, and
an encryption protocol is applied to the request message.

18. The server of claim 17, wherein:
the first monitoring request in the request message corresponds to a request for monitoring a plurality of status parameters associated with the plurality of remote devices, and
the plurality of status parameters includes one or more of an active call status, a presence status, an emergency alert status condition, status of a charge of a battery, a cell coverage, a signal strength, a current connection status, a current location, a roaming status, a profile status, a status of one or more sensors associated with the plurality of remote devices, and a health status indicated by sensor data corresponding to the plurality of remote devices, and
wherein the sensor data corresponds to data collected by wearable devices among the plurality of remote devices.

19. The server of claim 17, wherein:
the request message comprises a Session Initiation Protocol, SIP, message indicating the first monitoring request.

20. The method of claim 18, wherein:
the payload content type includes one of a TLV format, a JSON format, or an XML format, and
the TLV format includes a plurality of Information Elements, IE, indicating the plurality of status parameters associated with the plurality of remote devices and a type and reference corresponding to each of the plurality of status parameters.
